(19) United States
(12) Patent Application Publication
(10) Pub. No.: US 2019/0279223 A1
(43) Pub. Date: Sep. 12, 2019

(54) Dynamic Browser and Information Supporting Method for Business Agent

(71) Applicants: Tu Song-Anh Nguyen, Irvine, CA (US); John Le, Stanton, CA (US); Quang-Tuan Song Nguyen, Irvine, CA (US); Quang-Thang Song Nguyen, Irvine, CA (US); Quan Nguyen Phung, Poway, CA (US); Ly Nguyen Phung, Poway, CA (US)

(72) Inventors: Tu Song-Anh Nguyen, Irvine, CA (US); John Le, Stanton, CA (US); Quang-Tuan Song Nguyen, Irvine, CA (US); Quang-Thang Song Nguyen, Irvine, CA (US); Quan Nguyen Phung, Poway, CA (US); Ly Nguyen Phung, Poway, CA (US)

(21) Appl. No.: 15/916,209

(22) Filed: Mar. 8, 2018

(51) Int. Cl. G06Q 30/00; G06F 17/30

(52) U.S. Cl. CPC G06Q 30/016; G06F 17/30528; G06F 17/30867

(57) ABSTRACT

An information supporting method for business agent among a dynamic browser, a customer and the business agent, includes the steps of dynamically acquiring customer information data and customer question data, identifying keywords, executing search engine according to the keywords, executing database matching, and dynamically generating search results page to the customer.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a browser and an information supporting method, and more particularly to a dynamic browser and information supporting method for business agent.

### Description of Related Arts

Being a professor in a field needs a lot of specialized knowledge and much time to master the techniques at the fields. As a result, thinking about career change is a tough decision for most people. However, even though a professor in a field mastering much specialized knowledge may not good at words, which may affects the business marketing.

Nowadays, for example, a professional insurance sales depends on recommending and selling an appropriate specified insurance for a customer, which needs to know much specialized knowledge, such as the types and detailed content of the insurances. However, a newcomer cannot quickly master the specialized knowledge even though he or she has excellent communicative skill. While an insurance professor who masters much the specialized knowledge while who is weak at the communicative skill cannot support an excellent customer service for the customer. Therefore, many industries need to have a certain knowledge reserves to engage in, only master be professional to win the trust of customers. The patent writing staff, for example, before writing also needs to have a lot of knowledge input, and a lot of skills to help clients to write good patent. But now the society develops rapidly with large amount of information, data processing is becoming more and more faster; if he can't make good use of it, it will waste a lot of human resources. People are not easily to have a career change because that the career change needs to master the knowledge of new industry which is consuming of energy. However, everybody in the new industry is likely to be in accordance with the advantages of the industry. For example, a person with an affinity and persuasive is want to engaged in insurance sales industry, his own qualities can be good communication, and customers can easily get the trust of the customer, but not from a very short period of time to master a lot of insurance knowledge. This limits the potential good sales personnel. And in the insurance industry, people who have mastered a lot of insurance knowledge for many years is lack of eloquence. As a result, he cannot able to have the good insurance sales.

### SUMMARY OF THE PRESENT INVENTION

The invention is advantageous in that it provides a dynamic browser and information supporting method for business agent, which provides an information supporting system among a dynamic browser, a customer and the business agent.

Another advantage of the invention is to provide a dynamic browser and information supporting method for business agent, the business agent controls the dynamic browser to assist the customer service staff to communicate with the customer so as to provide an excellent customer service and so as to contribute to the business cooperation between the business agent and the customer.

Another advantage of the invention is to provide a dynamic browser and information supporting method for business agent, the information supporting system assists the customer service staff to communicate well with the customer even though the customer service staff is weakness on the specialized knowledge.

Another advantage of the invention is to provide a dynamic browser and information supporting method for business agent, the information supporting system assists the customer service staff to adjust communicative skills so as to communicate well with the customer.

Another advantage of the invention is to provide a dynamic browser and information supporting method for business agent, the information supporting system assists the customer service staff to adjust communicative skills by means of the dynamic browser dynamically analyzing the customer facial expression information.

Another advantage of the invention is to provide a dynamic browser and information supporting method for business agent, the information supporting system assists the business agent professor to communicate well with the customer even though the customer service staff is weakness on the communicative skills.

Another advantage of the invention is to provide a dynamic browser and information supporting method for business agent, the dynamic browser can provide professor answers which are directly generated by the business agent professor of the business agent.

Another advantage of the invention is to provide a dynamic browser and information supporting method for business agent, the dynamic browser provides online communication channels for the instant communication of the business agent professor of the business agent.

Another advantage of the invention is to provide a dynamic browser and information supporting method for business agent, the dynamic browser dynamically acquires customer information data and customer question data.

Another advantage of the invention is to provide a dynamic browser and information supporting method for business agent, the dynamic browser dynamically generates search results page to the customer.

Another advantage of the invention is to provide a dynamic browser and information supporting method for business agent, the dynamic browser responds data analysis results to the customer service staff.

Another advantage of the invention is to provide a dynamic browser and information supporting method for business agent, the customer service staff communicates with the customer according to the communication data analysis results from the dynamic browser.

Another advantage of the invention is to provide a dynamic browser and information supporting method for business agent, during the communication process between the customer service staff and the customer, the dynamic browser dynamically acquires customer facial expression information data of the customer and the customer service staff communicates with the customer according to the customer facial expression information data analysis results.

Another advantage of the invention is to provide a dynamic browser and information supporting method for business agent, during the communication process between the customer service staff and the customer, the dynamic browser dynamically acquires customer question data of the customer and the dynamic browser dynamically generates search results page to the customer.

Another advantage of the invention is to provide a dynamic browser and information supporting method for business agent, the business agent professor provides instant online professional knowledge service communication to the customer.

Another advantage of the invention is to provide a dynamic browser and information supporting method for business agent, the dynamic browser sends the professor answers form the business agent professor of the business agent to the customer.

Another advantage of the invention is to provide a dynamic browser and information supporting method for business agent, he dynamic browser provides online communication channels provides online communication channels for the instant communication of the business agent professor of the business agent so as to assist the further communication between the customer and the customer service staff.

Additional advantages and features of the invention will become apparent from the description which follows, and may be realized by means of the instrumentalities and combinations particular point out in the appended claims.

According to the present invention, the foregoing and other objects and advantages are attained by an information supporting method for business agent among a dynamic browser, a customer and the business agent, including the following steps of:

(A) the dynamic browser dynamically acquiring customer information data and customer question data;

(B) the dynamic browser identifying keywords;

(C) the dynamic browser executing search engine according to the keywords;

(D) the dynamic browser executing database matching; and

(E) the dynamic browser dynamically generating search results page to the customer.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of an information supporting system for business agent according to a preferred embodiment of the present invention.

FIG. 2 is a block diagram of an information supporting system for business agent according to the preferred embodiment of the present invention.

FIG. 3 is a block diagram of an information supporting system for business agent according to the preferred embodiment of the present invention.

FIG. 4 is a flow diagram of an information supporting system for business agent according to a preferred embodiment of the present invention.

FIG. 5 is a flow diagram of an information supporting system for business agent according to the preferred embodiment of the present invention.

FIG. 6 is a flow diagram of an information supporting system for business agent according to the preferred embodiment of the present invention.

FIG. 7 is a flow diagram of an information supporting system for business agent according to the preferred embodiment of the present invention.

FIG. 8 is a flow diagram of an information supporting system for business agent according to the preferred embodiment of the present invention.

FIG. 9 is a flow diagram of an information supporting system for business agent according to the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

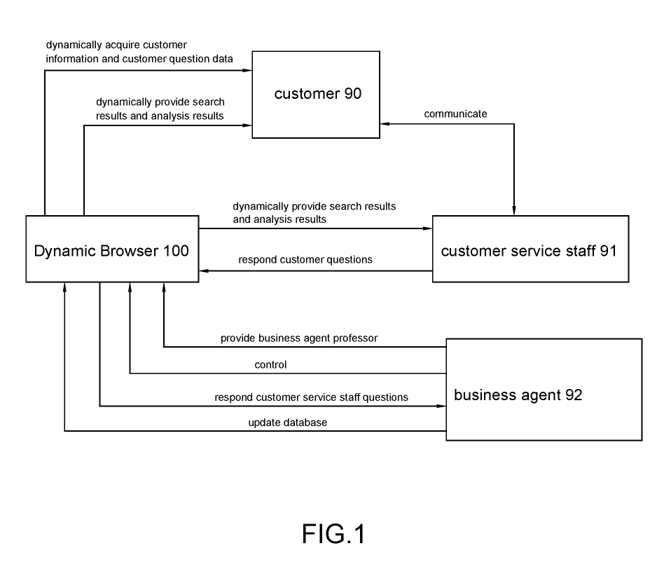

Referring to FIG. 1 to FIG. 3 of the drawings, an information supporting system for business agent according to a preferred embodiment of the present invention is illustrated. The information supporting system comprises a dynamic browser 100 providing information support among the customer 90, the customer service staff 91 and the business agent 92.

As shown in FIG. 1 of the drawings, the business agent 92 controls the dynamic browser 100 to assist the customer service staff 91 to communicate with the customer 90 so as to provide an excellent customer service and so as to contribute to the business cooperation between the business agent 92 and the customer 90. The customer service staff 91 is a person who has excellent communicative skill and can communicate well with the customer 90. The customer service staff 91 may not a professor at a specific filed relative to the business agent 92. However, the weakness on the specialized knowledge is not affect the customer service staff 91 to communicate with the customer 90 by means of the dynamic browser 100. According to the responds of the business agent 92 and the customer 90, the dynamic browser 100 dynamically acquires customer information and customer question data and the business agent 92 provides business agent professor to solve professional problems to assist the customer service staff 91 to communicate with the customer 90 so as to contribute to the business cooperation between the business agent 92 and the customer 90. As a result, the business agent professor can be a person who has masters much specialized knowledge but is weak at communicative skills.

In a further, during the communicating processing between the customer 90 and the customer service staff 91, the dynamic browser 100 dynamically acquires customer information and customer question data and automatically identifies keywords. The dynamic browser 100 has a database to provide information supporting and information analysis. After identifying the keywords, the dynamic browser 100 executes search engine according to the keywords and executes database matching and dynamically generates search results page to the customer 90. As a result, the customer 90 can dynamically and instantly obtain search results page relative to his or her communication with the customer service staff 91 and has a good user experience.

For the customer service staff 91, the dynamic browser 100 assists his or her to adjust communicative skills with the customer 90 and to remedy his or limitation of the weakness on the specialized knowledge. During the communicating processing between the customer 90 and the customer service staff 91, the customer service staff 91 responds customer questions to the dynamic browser 100 or the dynamic browser 100 dynamically acquires facial expression of the customer service staff 91 to dynamically provide search results and analysis results to the customer service staff 91 for adjusting communicative skills and solving professional problems of the customer 90 which the customer service staff 91 does not mastered. As a result, the customer service staff 91 can communicate well with the customer 90 and contribute to the business cooperation between the business agent 92 and the customer 90.

In a further, the business agent 92 is not only provide business agent professor, but also can control the dynamic browser 100 and updates the database of the dynamic browser 100 based on the customer service staff questions which the dynamic browser 100 responds.

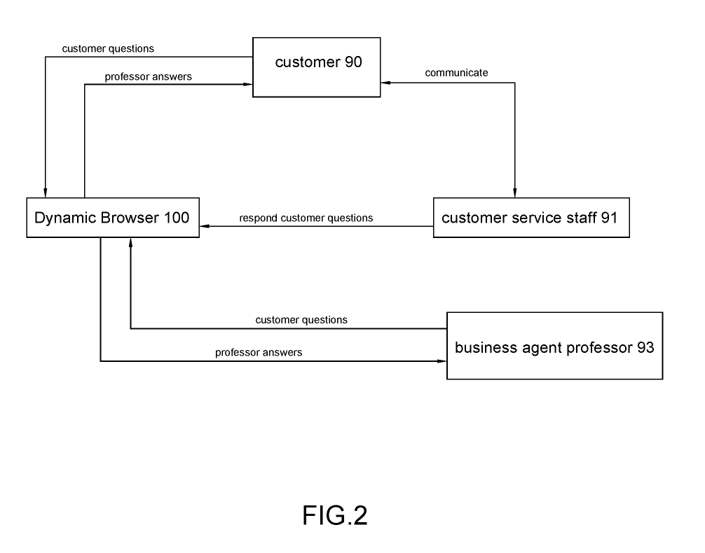

As shown in FIG. 2 of the drawings, although the dynamic browser 100 has a big database and is updated by the business agent 92, the dynamic browser 100 can also provide professor answers which are directly generated by the business agent professor 93 of the business agent 92. As a result, the customer 90 can timely obtain the professor answers of his or her specific customer questions.

The customer 90 sends his or her customer questions request to the dynamic browser 100 or the dynamic browser 100 automatically acquires the customer questions request from the customer 90, the dynamic browser 100 sends the customer questions data to the business agent professor 93 of the business agent 92. Then the business agent professor 93 of the business agent 92 analyzes the customer questions to obtain professor answers aiming at the customer questions. The business agent professor 93 of the business agent 92 sends the professor answers to the dynamic browser 100 and the dynamic browser 100 responds the professor answers to the customer 90 in time. In this information supporting way, the business agent professor 93 of the business agent 92 provides professor answers to the customer 90 by the dynamic browser 100 sending the professor answers to the customer 90.

During the communicating processing between the customer 90 and the customer service staff 91, the customer service staff 91 can also respond customer questions to the dynamic browser 100, the dynamic browser 100 sends the customer questions data to the business agent professor 93 of the business agent 92. Then the business agent professor 93 of the business agent 92 analyzes the customer questions to obtain professor answers aiming at the customer questions. The business agent professor 93 of the business agent 92 sends the professor answers to the dynamic browser 100 and the dynamic browser 100 responds the professor answers to the customer service staff 91 to assist the further communication between the customer 90 and the customer service staff 91.

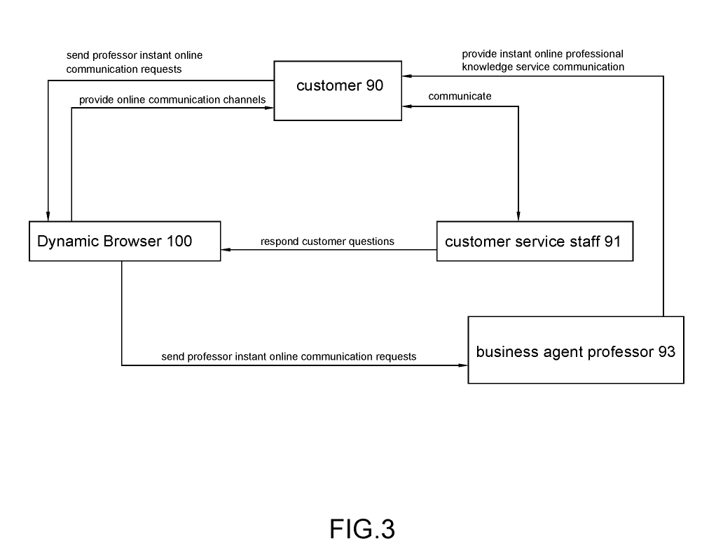

As shown in FIG. 3 of the drawings, although the dynamic browser 100 is updated by the business agent 92 and has a big database, the dynamic browser 100 can also provide professor answers which are directly generated by the business agent professor 93 of the business agent 92 to avoid failure of database mapping. As a result, the customer 90 can instant obtain the professor answers of his or her specific customer questions online. In other words, in this information supporting way, the dynamic browser 100 provides online communication channels for the instant communication of the business agent professor 93 of the business agent 92.

The customer 90 sends his or her professor instant online communication requests to the dynamic browser 100 or the dynamic browser 100 automatically acquires the professor instant online communication requests from the customer 90, the dynamic browser 100 sends the professor instant online communication requests data to the business agent professor 93 of the business agent 92. Then the business agent professor 93 of the business agent 92 analyzes the customer questions to obtain professor answers aiming at the customer questions. The dynamic browser 100 provides online communication channels provides online communication channels for the instant communication of the business agent professor 93 of the business agent 92. The business agent professor 93 of the business agent 92 provides instant online professional knowledge service communication with the customer 90 by means of the online communication channels provided by the dynamic browser 100. In this information supporting way, the business agent professor 93 of the business agent 92 provides instant online professional knowledge service communication to provide professor answers to the customer 90 by the dynamic browser 100 providing online communication channels for the instant communication of the business agent professor 93 of the business agent 92.

During the communicating processing between the customer 90 and the customer service staff 91, the customer service staff 91 can also respond customer questions to the dynamic browser 100, the dynamic browser 100 sends the customer questions data to the business agent professor 93 of the business agent 92. Then the business agent professor 93 of the business agent 92 analyzes the customer questions to obtain professor answers aiming at the customer questions. The dynamic browser 100 provides online communication channels provides online communication channels for the instant communication of the business agent professor 93 of the business agent 92. The business agent professor 93 of the business agent 92 provides instant online professional knowledge service communication with the customer 90 to assist the further communication between the customer 90 and the customer service staff 91.

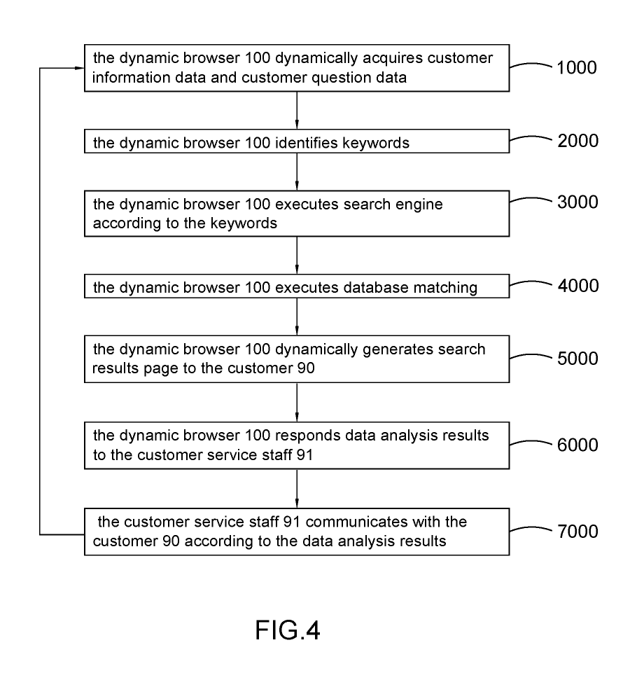

Referring to FIG. 4 to FIG. 9 of the drawings, an information supporting method for business agent according to an embodiment of the present invention is illustrated.

As shown in FIG. 4 of the drawings, the information supporting method for business agent through a dynamic browser 100 comprises the following steps:

(1000) The dynamic browser 100 dynamically acquires customer information data and customer question data.

(2000) The dynamic browser 100 identifies keywords.

(3000) The dynamic browser 100 executes search engine according to the keywords.

(4000) The dynamic browser 100 executes database matching.

(5000) The dynamic browser 100 dynamically generates search results page to the customer 90.

(6000) The dynamic browser 100 responds data analysis results to the customer service staff 91.

(7000) The customer service staff 91 communicates with the customer 90 according to the data analysis results.

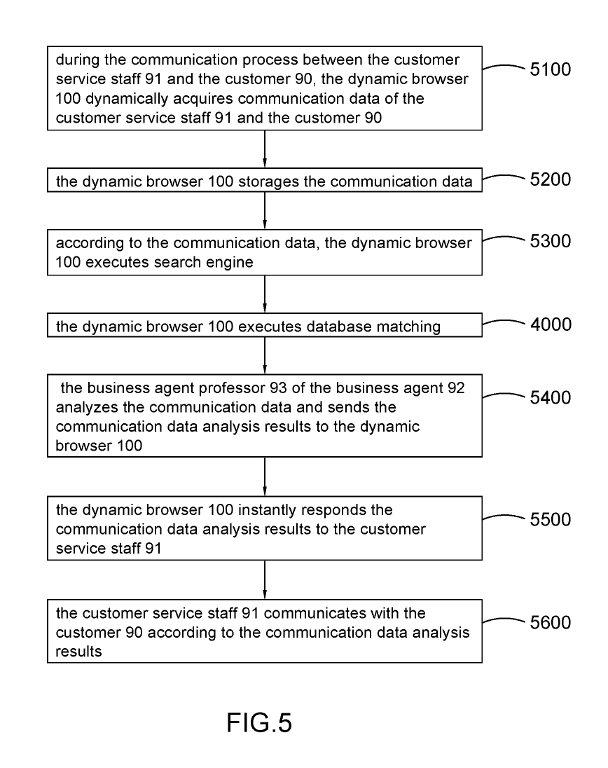

As shown in FIG. 5 of the drawings, the information supporting method for business agent comprises the following steps:

(5100) During the communication process between the customer service staff 91 and the customer 90, the dynamic browser 100 dynamically acquires communication data of the customer service staff 91 and the customer 90.

(5200) The dynamic browser 100 storages the communication data.

(5300) According to the communication data, the dynamic browser 100 executes search engine.

(4000) The dynamic browser 100 executes database matching.

(5400) The business agent professor 93 of the business agent 92 analyzes the communication data and sends the communication data analysis results to the dynamic browser 100.

(5500) The dynamic browser 100 instantly responds the communication data analysis results to the customer service staff 91.

(5600) The customer service staff 91 communicates with the customer 90 according to the communication data analysis results.

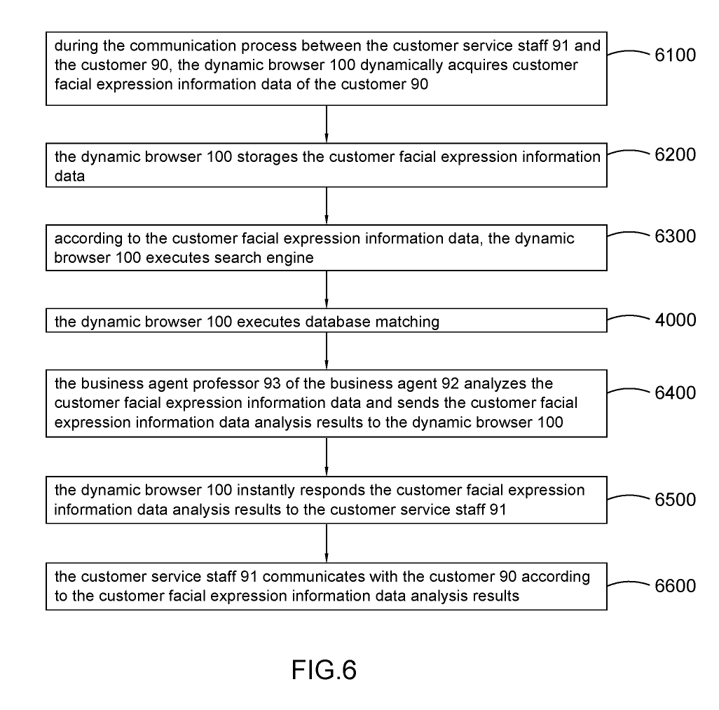

As shown in FIG. 6 of the drawings, the information supporting method for business agent comprises the following steps:

(6100) During the communication process between the customer service staff 91 and the customer 90, the dynamic browser 100 dynamically acquires customer facial expression information data of the customer 90.

(6200) The dynamic browser 100 storages the customer facial expression information data.

(6300) According to the customer facial expression information data, the dynamic browser 100 executes search engine.

(4000) The dynamic browser 100 executes database matching.

(6400) The business agent professor 93 of the business agent 92 analyzes the customer facial expression information data and sends the customer facial expression information data analysis results to the dynamic browser 100.

(6500) The dynamic browser 100 instantly responds the customer facial expression information data analysis results to the customer service staff 91.

(6600) The customer service staff 91 communicates with the customer 90 according to the customer facial expression information data analysis results.

For the customer service staff 91, the dynamic browser 100 assists his or her to adjust communicative skills with the customer 90 according to the customer facial expression information data analysis results from the dynamic browser 100. During the communicating processing between the customer 90 and the customer service staff 91, the dynamic browser 100 dynamically acquires facial expression of the customer service staff 91 or the dynamic browser 100 dynamically acquires facial expression of the customer 90 to dynamically provide facial expression search results and analysis results to the customer service staff 91 for adjusting communicative skills and solving facial expression problems of the customer 90 which the customer service staff 91 does not mastered. The dynamic browser 100 can provides the customer facial expression information data analysis results based on the micro-expressions psychology. As a result, on one hand, the customer service staff 91 can communicate well with the customer 90 and contribute to the business cooperation between the business agent 92 and the customer 90. On the other hand, the customer 90 can dynamically and instantly obtain search results page relative to his or her communication with the customer service staff 91 and has a good user experience.

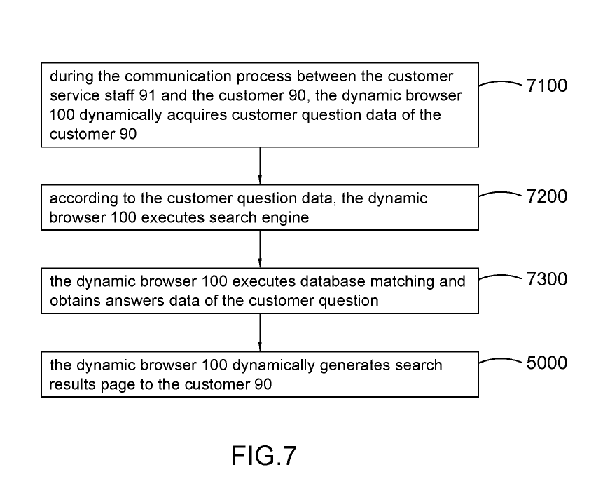

As shown in FIG. 7 of the drawings, the information supporting method for business agent comprises the following steps:

(7100) During the communication process between the customer service staff 91 and the customer 90, the dynamic browser 100 dynamically acquires customer question data of the customer 90.

(7200) According to the customer question data, the dynamic browser 100 executes search engine.

(7300) The dynamic browser 100 executes database matching and obtains answers data of the customer question.

(5000) The dynamic browser 100 dynamically generates search results page to the customer 90.

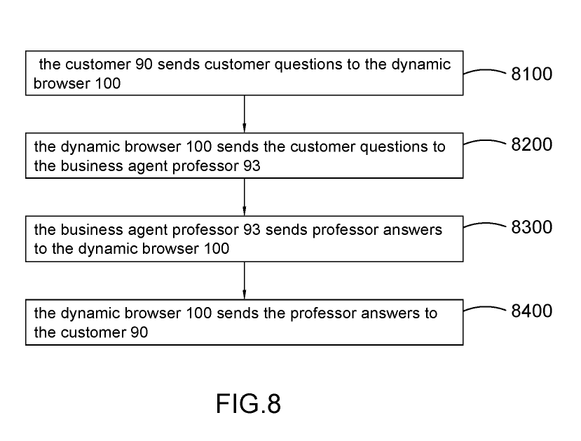

As shown in FIG. 8 of the drawings, the information supporting method for business agent comprises the following steps:

(8100) The customer 90 sends customer questions to the dynamic browser 100.

(8200) The dynamic browser 100 sends the customer questions to the business agent professor 93.

(8300) The business agent professor 93 sends professor answers to the dynamic browser 100.

(8400) The dynamic browser 100 sends the professor answers to the customer 90.

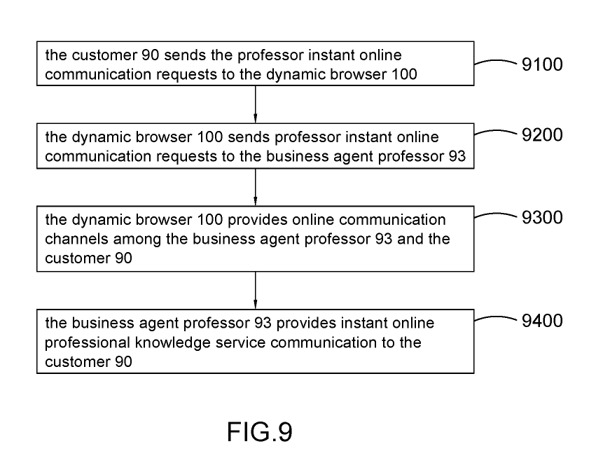

As shown in FIG. 9 of the drawings, the information supporting method for business agent comprises the following steps:

(9100) The customer 90 sends the professor instant online communication requests to the dynamic browser 100.

(9200) The dynamic browser 100 sends professor instant online communication requests to the business agent professor 93.

(9300) The dynamic browser 100 provides online communication channels among the business agent professor 93 and the customer 90.

(9400) The business agent professor 93 provides instant online professional knowledge service communication to the customer 90.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An information supporting method for business agent among a dynamic browser, a customer and the business agent, comprising the steps of:
(A) dynamically acquiring customer information data and customer question data by the dynamic browser;
(B) identifying keywords by the dynamic browser;
(C) executing search engine according to the keywords by the dynamic browser;
(D) executing database matching by the dynamic browser; and
(E) dynamically generating search results page by the dynamic browser to the customer.

2. The information supporting method for business agent, as recited in claim 1, after the step (C), further comprising the steps of:
responding data analysis results to the customer service staff by the dynamic browser; and
communicating the customer service staff with the customer according to the data analysis results.

3. The information supporting method for business agent, as recited in claim 1, before said step (C), further comprising the steps of:
during the communication process between the customer service staff and the customer, dynamically acquiring communication data of the customer service staff and the customer by the dynamic browser; and
according to the communication data, executing search engine by the dynamic browser.

4. The information supporting method for business agent, as recited in claim 3, before said executing search engine step, further comprising a step of storing the communication data by the dynamic browser.

5. The information supporting method for business agent, as recited in claim 3, further comprising the steps of:
analyzing the communication data and sending the communication data analysis results to the dynamic browser by the business agent professor of the business agent;
instantly responding the communication data analysis results to the customer service staff by the dynamic browser; and
communicating the customer service staff with the customer according to the communication data analysis results.

6. The information supporting method for business agent, as recited in claim 1, before said step (C), further comprising the steps of:
during the communication process between the customer service staff and the customer, dynamically acquiring customer facial expression information data of the customer by the dynamic browser; and
according to the customer facial expression information data, executing search engine by the dynamic browser.

7. The information supporting method for business agent, as recited in claim 6, before said executing search engine step, further comprising a step of storing the customer facial expression information data by the dynamic browser.

8. The information supporting method for business agent, as recited in claim 6, after said step (C), further comprising the steps of:
instantly responding the customer facial expression information data analysis results to the customer service staff by the dynamic browser; and
communicating the customer service staff with the customer according to the customer facial expression information data analysis results.

9. The information supporting method for business agent, as recited in claim 8, further comprising a step of analyzing the customer facial expression information data and sending the customer facial expression information data analysis results to the dynamic browser by the business agent professor of the business agent.

10. The information supporting method for business agent, as recited in claim 1, before said step (E), further comprising the steps of:
during the communication process between the customer service staff and the customer, the dynamic browser dynamically acquiring customer question data of the customer;
according to the customer question data, the dynamic browser executing search engine; and
the dynamic browser executes database matching and obtaining answers data of the customer question.

11. The information supporting method for business agent, as recited in claim 1, further comprising the steps of:
during the communication process between the customer service staff and the customer, the dynamic browser dynamically acquiring customer question data of the customer;
according to the customer question data, the dynamic browser executing search engine; and
the dynamic browser executes database matching and obtaining answers data of the customer question.

12. The information supporting method for business agent, as recited in claim 1, further comprising a step of sending customer questions by the customer to the dynamic browser.

13. The information supporting method for business agent, as recited in claim 12, further comprising a step of sending the customer questions to the business agent professor by the dynamic browser.

14. The information supporting method for business agent, as recited in claim 13, further comprising a steps of sending professor answers by the business agent professor to the dynamic browser.

15. The information supporting method for business agent, as recited in claim 14, further comprising a step of sending the professor answers by the dynamic browser to the customer.

16. The information supporting method for business agent, as recited in claim 1, further comprising the steps of:
sending the professor instant online communication requests to the dynamic browser from the customer;
sending professor instant online communication requests to the business agent professor from the dynamic browser;
providing online communication channels among the business agent professor and the customer by the dynamic browser; and
providing instant online professional knowledge service communication to the customer by the business agent professor.
